(19) United States
(12) Patent Application Publication
(10) Pub. No.: US 2009/0011885 A1
(43) Pub. Date: Jan. 8, 2009

(54) Rotary Regenerative Heat Exchange Wheel Assembly with Improved Flexible Drive Belt Link for Easy Assembly and Disassembly

(75) Inventor: Keith Robinson, Marshfield Hills, MA (US)

Correspondence Address: MCDERMOTT WILL & EMERY LLP, 28 STATE STREET, BOSTON, MA, 02109-1775, US

(73) Assignee: AIRXCHANGE, INC.

(21) Appl. No.: 12/132,929

(22) Filed: Jun. 4, 2008

Related U.S. Application Data
(60) Provisional application No. 60/933,219, filed on Jun. 5, 2007.

(51) Int. Cl. F16G 7/02

(52) U.S. Cl. 474/257

(57) ABSTRACT

A rotary regenerative heat exchange wheel assembly of the type including a rotary wheel constructed to rotate about an axis, and driven with a belt drive, the assembly comprising: a flexible belt of a predetermined cross section, including an elongated strip terminating at two ends, each end being formed with a slot, and a flexible link sized so as to extend to each slot; and at least one fastening device for securing the flexible link to each end of the strip.

### RELATED APPLICATION

The present application is based upon and claims priority from U.S. Provisional Application No. 60/933,219 filed Jun. 5, 2007.

### FIELD OF THE DISCLOSURE

The present invention relates to an improved energy recovery wheel system, and more particularly to an improved rotary regenerative heat exchange wheel assembly particularly adapted for use in relatively large HVAC systems having a wheel driven by a drive belt that is constructed to be easily repaired, replaced and maintained.

### BACKGROUND OF THE DISCLOSURE

In designing and installing relatively large capacity HVAC units it is the customary practice to size the cooling and heating equipment to handle both the building load and the ventilation load at the extremes of summer and winter design conditions. To assure comfort above and below these temperatures that only occur during approximately 2.5% of a total heating or cooling season, over sizing of equipment is standard practice, adding significant capital cost for heating and cooling capacity that is only utilized a small percentage of the year.

To solve the energy cost problems associated with these HVAC units, people have closed outside air dampers. This achieves a reduction in the energy consumption for heating and cooling a building, but creates poor ventilation.

It is generally known that rotary regenerative heat exchange assemblies can be used to capture heat and moisture from warm air and transfer the heat and moisture to cool air. Thus, when heating a building and cool dry air is drawn from the outside into the building and heated moist air is exhausted from the building, a rotary regenerative heat wheel assembly can be utilized to capture some of the heat and moisture from the exiting air, and transfer the heat and moisture to the incoming air. Conversely, when cooling a building, a rotary regenerative heat wheel assembly can be utilized to capture some of the heat and humidity from the incoming air and transferring the heat and humidity to the exiting air so that cooler, dryer air enters the building. Incorporating a rotary regenerative heat exchange assembly in HVAC systems can create problems regarding maintenance and repair of the assembly. One problem relates to replacing drive belts that couple drive motors to the rotary regenerative heat exchange wheels.

Accordingly, it is desirable to provide a rotary regenerative heat exchange assembly with an improved flexible drive belt having a connecting link constructed so as to facilitate the assembly and disassembly of the belt on the assembly both at the factory and in the field. The ease with which the belt can be assembled and disassembled is particularly useful in assemblies with relatively large wheel assemblies.

### SUMMARY OF THE DISCLOSURE

A rotary regenerative heat exchange wheel assembly of the type including a rotary wheel constructed to rotate about an axis, and driven with a belt drive, the assembly comprising: a flexible belt of a predetermined cross section, including an elongated strip terminating at two ends, each end being formed with a slot, and a flexible link sized so as to extend to each slot; and at least one fastening device for securing the flexible link to each end of the strip.

### GENERAL DESCRIPTION OF THE DRAWINGS

For a fuller understanding of the nature and objects of the present invention, reference should be had to the following detailed description taken in connection with the accompanying drawings wherein:

FIG. 1 is a schematic view of a building utilizing a HVAC system incorporating the rotary regenerative heat exchange assembly of the present invention;

FIG. 2 is a perspective view of the rotary regenerative heat exchange assembly connected in the ductwork of the system shown in FIG. 1, with the cover removed and the “cassette” portion of the assembly partially removed from its operating position;

FIG. 3 is a top view of the of the link portion, in a secured position, of the flexible belt used to rotatably drive a wheel, such as for example the one shown in FIGS. 1 and 2;

FIG. 4 is a side view of the link portion of the flexible belt shown in FIG. 3;

FIG. 5 is a top view of the link portion of FIG. 3, shown disconnected at one end;

FIG. 6 is a side view showing the disconnected link portion of FIG. 5, with one end configured to receive the other end;

FIG. 7 is a top view showing the link portion of FIG. 3, showing the ends connected, prior to being secured;

FIG. 8 is a side view of FIG. 7; and

FIG. 9 is a cross-sectional view, partially cut-away, showing the belt positioned in the groove of a pulley so as to illustrate the mating of the cross-section of the belt and belt link portion and the groove of a pulley or wheel.

### DETAILED DESCRIPTION OF THE DRAWINGS

The same numerals are used in the various figures of the drawings to designate the same or similar parts.

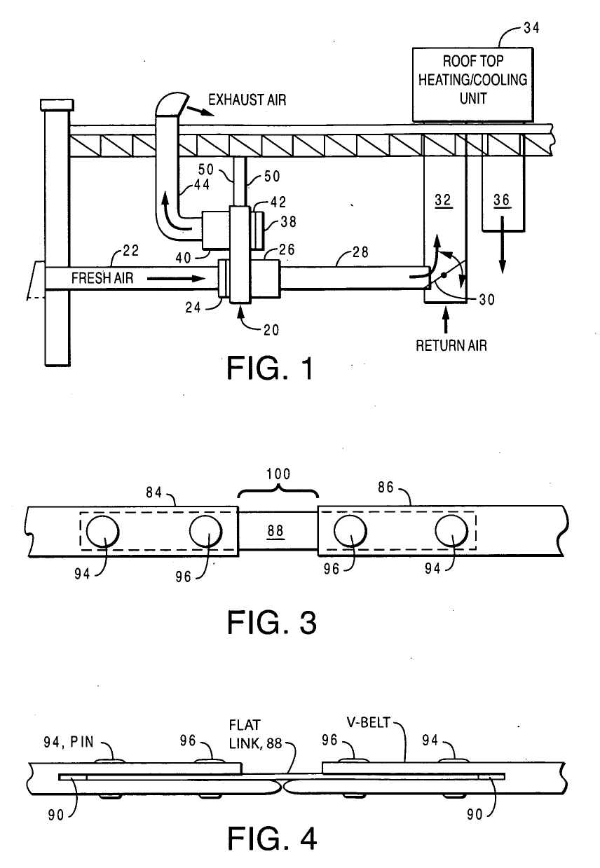

In FIG. 1, a typical HVAC system is modified to include the rotary regenerative heat exchange wheel assembly 20 in accordance with the principles of the present invention. More specifically, fresh air is drawn by the indoor blower 26 from the outside into the intake duct, indicated at 22, through air filter 24 and thence through the air intake side of the heat exchange wheel assembly 20. The fresh air is drawn through the heat exchange wheel, described in greater detail hereinafter, through the blower 26 into the transfer duct 28. In the system shown, duct 28 is connected to the air intake duct 32 for the rooftop heating/cooling unit 34. A damper 30 is provided so that interior air can be mixed with the air provided from the duct 28 so that interior air can be recirculated through the unit 34 in a manner well known in the art. Air is treated by the unit 34 (heated during cold weather and cooled during warm weather) and passed back into the interior of the building through the duct 36. Exhaust air is drawn by exhaust blower 40 through the filter 38 into a duct 42, through the air output side of the heat exchange wheel assembly 20, through the blower 40 into the exhaust duct 44 so that the exhaust air is vented to the outside.

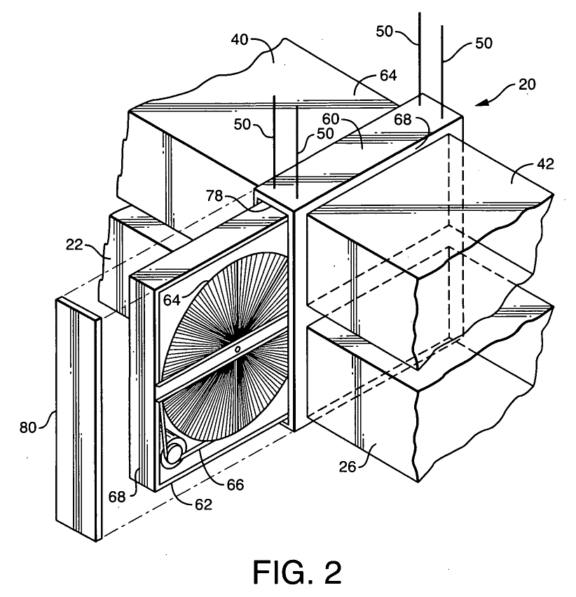

The assembly 20, illustrated in greater detail in FIG. 2, is preferably suitably supported, such as by suspending the assembly from the ceiling with the suspension cables 50, so as to place a minimum load on the duct work. The assembly 20 includes a cabinet 60 and a heat exchange wheel means in the form of “cassette” 62 mounted to slide into and out of the cabinet as indicated at 78. The cassette 62 supports the wheel 64 which is driven by a drive belt 66. The belt couples a motor 68 to the wheel. Typically, the motor shaft is fixed to a pulley provided with a peripheral groove for engaging the belt. Similarly, the belt 66 engages a similar groove formed in the perimeter or rim of the wheel 64, or a pulley fixed to rotate with the wheel about the same rotation axis.

The belt 66 is designed and constructed to be easily replaced despite the size of the wheel, and the construction of the cassette without the necessity of disassembling the cassette. As seen in FIG. 3, the belt 66 includes an elongated strip terminating at opposite ends 84 and 86. An improved fastening link 88 is provided to facilitate fastening together two ends 74 and 76 of a wheel drive belt material in order to form a continuous drive belt. The fastening link shown at 88 can be used with different profile (cross-sectional) belts such are V, flat or round, and on various belt materials such as urethane or rubber, etc. The example illustrated in FIGS. 3-9 is a V-shaped belt made for example of urethane. The link can be utilized to create continuous drive belts of a desired length, or, to replace a worn or broken drive belt that would otherwise require the removal of supporting components of the wheel in order to install a continuous drive belt around the perimeter of the wheel. The improved link can be easily assembled onto an existing wheel assembly by using a link whereby the belt material is first wound around the wheel, and the ends joined by the link.

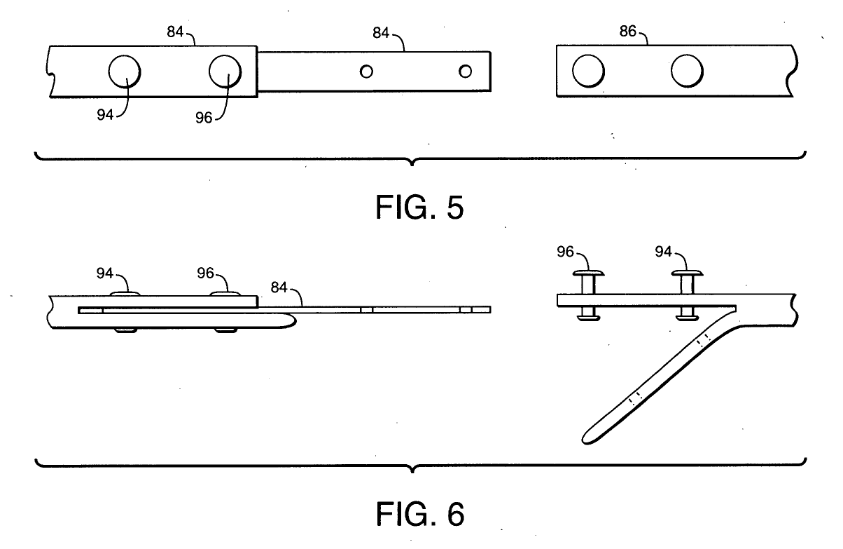

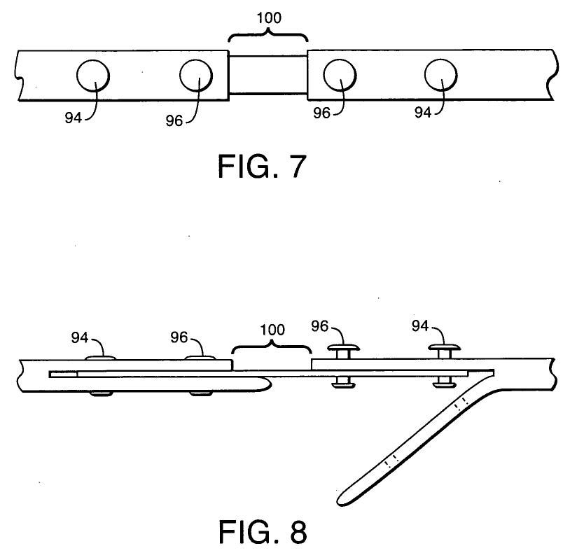

Referring to FIGS. 3-9, extruded urethane V profile drive belt material is joined to manufacture a continuous belt by slotting the ends of the V belt (the slots illustrated at 90 running from the opposite sides of each end of the belt), and inserting the link 88 preferably in the form of a flat piece of flexible material, for example flat timing belt material, within the slots. Once inserted each belt end is fastened to the link belt using at least one, and preferably two through pins 94 and 96 so as to form the joint 100. For field replacement, one side of the link can be provided previously assembled by the factory as shown in FIGS. 5 and 6. No supporting components of the wheel assembly need to be removed to install the replacement belt. Simply position the new belt material around the perimeter of the wheel for example, and assemble the second half of the link joint 100. The joint is assembled by positioning the flat link within the belt slot and engaging the two holes of the link over the existing pins 94 and 96 previously installed to the top strip of the V belt end as shown in FIGS. 7 and 8. Finally, the bottom strip of the V belt end is engaged onto the pins by pressing the bottom strip over the pin heads until the pins pass through the bottom strip and capture the upper and lower V belt end strips and flat link belt within the pin heads as shown in FIGS. 6 and 7. The pin heads are preferably designed with a special barbed end 102 to pass through the urethane material easily, but are difficult to back out.

Unique to the link joint is how the bottom strips of the V belt ends protrude to the center of the flat link belt with only a small gap between their ends. This V belting underneath the flat link belt supports the flat link belt material as the joint is flexed around a pulley causing the joint to maintain a uniform radius rather than allowing the flat belt to flatten out as it is flexed. This relieves stress at the line where the flat belt would otherwise bend about the urethane belt end as it flexes about a small pulley diameter. The small gap between the bottom V belt strip allows clearance for the gap to close up as the joint is flexed. The V belt strips underneath the flat link belt also have rounded ends to relieve bending moment and stress and wear of the link belt material at that location.

The upper strips of the V belt ends can be trimmed back towards the first pin of each joint to prevent them from bending outward and catching against fixed objects during rotation.

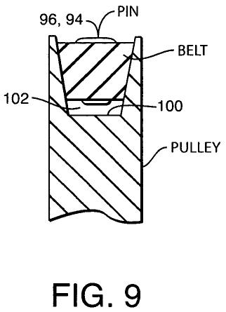

As shown in FIG. 9, the belt preferably is shaped to sit in the pulley groove with clearance at the bottom to avoid pressing and wear on the pin.

This joint system can be modified to be used on various V belt sized profiles, for example an A or 3L profile by using different width flat link belt materials and different size fastening pins.

Since certain changes may be made in the above apparatus without departing from the scope of the invention herein involved, it is intended that all matter contained in the above description or shown in the accompanying drawing shall be interpreted in an illustrative and not in a limiting sense.

What is claimed is:

1. A rotary regenerative heat exchange wheel assembly of the type including a rotary wheel constructed to rotate about an axis, and driven with a belt drive, the assembly comprising:
a flexible belt of a predetermined cross section, including an elongated strip terminating at two ends, each end being formed with a slot, and a flexible link sized so as to extend to each slot; and
at least one fastening device for securing the flexible link to each end of the strip.

2. A wheel assembly according to claim 1, wherein the flexible link is a flat strip of material.

3. A wheel assembly according to claim 1, wherein each fastening device is a pin.

4. A wheel assembly according to claim 3, wherein the pin is provided with a barbed end so that the pin can be more easily inserted into the ends of the strip, and held in place.

5. A wheel assembly according to claim 1, wherein at least two fastening devices are provided for securing the flexible link to each end of the strip.

6. A wheel assembly according to claim 5, wherein each fastening device is a pin.

7. A wheel assembly according to claim 6, wherein the pin is provided with a barbed end so that the pin can be more easily inserted into the ends of the strip, and held in place.

8. A wheel assembly according to claim 7, wherein the belt engages a groove of a rim of a rotating element, wherein the belt is provided with a cross-section so as to be spaced from the bottom of the groove.

9. A wheel assembly according to claim 8, wherein the rotating element is a wheel.

10. A wheel assembly according to claim 8, wherein the rotating element is a pulley.
